(19) United States
(12) Patent Application Publication
(10) Pub. No.: US 2026/0169699 A1
(43) Pub. Date: Jun. 18, 2026

(54) SYSTEMS AND METHODS FOR CODE DEPENDENCY REPLACEMENT

(71) Applicant: SAP SE, Walldorf (DE)

(72) Inventors: Serena PONTA, Mouans Sartoux (FR); Antonino SABETTA, Mouans Sartoux (FR); Piergiorgio LADISA, Amsterdam (NL); Wolfram Fischer, Stuttgart (DE)

(21) Appl. No.: 18/979,168

(22) Filed: Dec. 12, 2024

(51) Int. Cl. G06F 8/30

(52) U.S. Cl. CPC G06F 8/30

(57) ABSTRACT

Embodiments of the present disclosure include techniques for analyzing and reducing dependent code. In one embodiment, application source code is linked to dependency code, some of which is used and some of which is not used. The application source code and dependency code are analyzed to produce a usage graph comprising nodes corresponding to functional code elements and edges between the nodes corresponding to calls between the code elements. Edges may be associated with weights that may be used to determine an amount of used in subtrees of the dependency code. Dependency code that is little used may be replaced by dependency code without indirect dependencies. Replacement dependency code may be autogenerated by extracting existing dependency code elements to build a prompt for a generative AI.

### BACKGROUND

The present disclosure relates generally to computer software systems, and in particular, to systems and methods for code dependency replacement.

Automated package management tools allow developers to find and integrate software components into their projects with minimal effort. For example, given the widespread use of open-source software, automated package management tools allow developers to easily find and integrate third-party open-source components into their applications. To reuse already developed functionalities, developers just need to declare a direct dependency on an existing software component (e.g., an open source component). It is often the case that a single component offers a plethora of functionalities and relies on other components on its own to implement those.

However, in practice, only a fraction of the functionalities (and code) of a dependency may be needed, and entire components could be redundant. When a package manager retrieves dependent code, the package manager may retrieve a large portion of code that is unused by the application, for example. Problematically, unused dependency code is burden for security and maintainability. Unused dependent code elements may contribute to extending the attack surface of the application. For example, unused code may include gadget classes leading to deserialization vulnerabilities, which needs to be maintained.

Therefore, typical applications suffer from the technical challenge of managing code dependencies that may incorporate unused code. The following disclosure provides various solutions to technical problems associated with code dependencies.

### BRIEF DESCRIPTION OF THE DRAWINGS

FIG. 1 illustrates a system for code dependency analysis and replacement according to an embodiment.

FIG. 2 illustrates a method for code dependency analysis and replacement according to an embodiment.

FIG. 3 illustrates an example software system for generating replacement code according to an embodiment.

FIG. 4 illustrates an example method of generating replacement code according to another embodiment.

FIG. 5 illustrates hardware of a special purpose computing system configured according to the above disclosure.

### DETAILED DESCRIPTION

Described herein are techniques for code dependency replacement. In the following description, for purposes of explanation, numerous examples and specific details are set forth in order to provide a thorough understanding of some embodiments. Various embodiments as defined by the claims may include some or all of the features in these examples alone or in combination with other features described below and may further include modifications and equivalents of the features and concepts described herein.

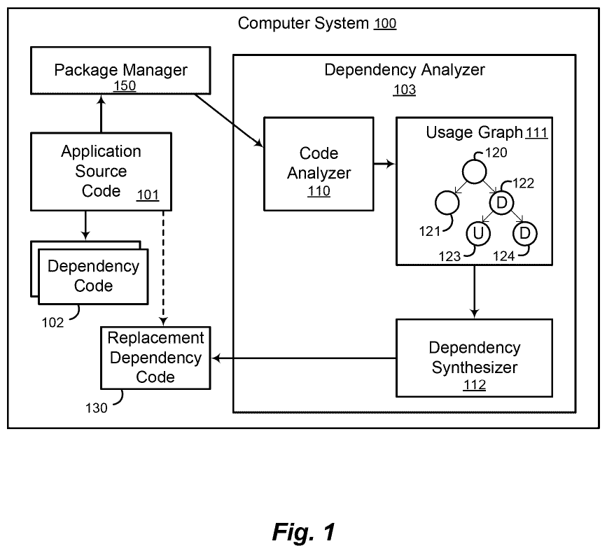

FIG. 1 illustrates a system for analyzing and replacing dependency code according to an embodiment. Features and advantages of the present disclosure include dependency analyzer software 103 executing on a computer system 100. Computer system 100 may include, for example, one or more computers comprising one or more processors and a computer readable medium (memory) for executing software to perform the techniques described herein. Here, embodiments of the present disclosure include techniques for analyzing application dependency code and generating replacement code that is more efficient and safer than initial dependency code. For example, is often the case that a single dependency code component offers a plethora of functionalities and relies on other code elements (or components) to implement certain functionalities. As a result, the dependencies of an application form a dependency tree made of direct and transitive dependencies. However, the application may not use all code elements of a dependency tree. Thus, it would be beneficial to identify the unused code elements and rebuild the code around code elements used by the application, while eliminating unused code elements. Additionally, unused code elements may pose security risks. For example, each known vulnerability (e.g., Common Vulnerabilities and Exposures or “CVEs”) reported for unused direct or transitive dependencies needs to be assessed by the application developer, thereby creating more inefficiencies.

Embodiments of the present disclosure overcome the technical challenges associated with incorporating dependency code into an application by providing a dependency analyzer that analyzes the dependency code to build a dependency tree. The dependency tree may be used to generate a dependency score, which may be used to trigger generation of replacement dependency code that does not include some or all of the unused code. Further examples for overcoming the technical challenges are described in more detail below.

A package manager (aka package management system) is a collection of software tools that typically automates the process of installing, upgrading, configuring, and/or removing computer programs for a computer in a consistent manner. In some cases, a package manager 150 (e.g., Maven or NPM) may retrieve the code dependencies from the application. Once downloaded and available, the dependencies may be input to dependency analyzer 103, for example. In this example, a dependency analyzer 103 executing on computer system 100 includes a code analyzer software component 110 that receives and analyzes application source code 101 and dependency code 102 external to the application source code. Code analyzer 110 determines dependencies between code elements of the application source code and dependency code elements of dependency code 102. Dependency code 102 may comprise libraries of functionalities accessible by an application, and in some cases may be available as open source code, for example. As used herein, the term code element refers to static and dynamic (execution time) functional component of the code that performs a particular process or algorithm to implement a particular functionality when invoked, such as functions, procedures, methods, subroutines, as well as runtime calls. As used herein, the term code element is synonymous with functional code element, code component, or functional component, or language specific terms such as procedures, functions, methods, etc., . . . , for example. Dependency code elements are code elements external to the application source code that are called by the application source code to perform a variety of functions. As mentioned above, particular dependency code elements directly accessed by application source code 101 may invoke further dependency code elements (e.g., indirect dependency code elements), which may in turn invoke further dependency code elements, for example. However, dependency code 102 may comprise a plurality of code elements that are used by the application as well as additional code elements that are not used by the application.

Code analyzer 110 may generate a usage graph 111 based on the application source code 101 and dependency code 102. Usage graph 111 comprises a plurality of nodes corresponding to code elements and dependency code elements and a plurality of edges between the nodes corresponding to dependency relations between particular nodes. For example, a usage graph may comprise a tree data structure (e.g., stored in memory, such as DRAM) where nodes of the tree correspond to code elements (functions) and edges between the nodes correspond to dependencies between code elements. FIG. 1 shows an illustrative subtree, where node 120 is a code element that calls code elements corresponding to nodes 121 and 122. Thus, node 120 has edges to nodes 121 and 122. Similarly, node 122 may be a code element that calls code elements 123 and 124. Thus, node 122 has edges to nodes 123 and 124, for example. By way of example, node 120 may be a code element (e.g., function, method, or procedure) in application source code 101 that invokes a dependency code element in dependency code 102 represented in the usage graph 111 as node 122, and node 122 may invoke additional dependency code elements corresponding to nodes 122 and 123, for example.

As further illustrated in FIG. 1, some code elements of the dependency code 102 may be used while others are unused. As illustrated in FIG. 1. code elements for nodes 122 and 124 contain code that is invoked by the application (e.g., at some point or under some conditions of the application's execution) while code element for node 123 is not used by the application (e.g., under any conditions or state of the application). Typically, however, when a particular code element is determined to be dependent, all the code elements called by the particular dependent code element are retrieved and used in an application. In some cases, unused dependent code elements can comprise large volumes of code, some of which may contain security risks. Accordingly, embodiments of the present disclosure may replace some or all of the code elements (and indirect code elements) of a subtree of dependent code 102 to advantageously eliminate unused code.

Embodiments of the present disclosure may advantageously determine which dependency code is to be replaced. For example, dependency synthesizer software component 112 may receive usage graph 111 and associate weights with edges of the graph. In various embodiments, the weights may correspond to different indicia indicating a benefit of replacing portions of the dependency code. For example, in some embodiments, the weights may correspond to a number of lines of code associated with particular dependency code elements (e.g., to determine the lines of code for used or unused dependency code elements relative to the total lines of code). In other embodiments, the weights may correspond to a cyclomatic complexity associated with particular dependency code elements. Cyclomatic complexity is a software metric used to indicate the complexity of a program. It is a quantitative measure of the number of linearly independent paths through a program's source code. In yet other embodiments, the weights may correspond to a number of detected known vulnerabilities associated with particular dependency code elements, for example.

Next, the system may generate dependency scores based on the plurality of weights. The dependency scores may be calculated for different subtrees of the usage graph comprising dependency code. For example, a dependency score may be calculated for the subtree comprising nodes 122, 123, and 124, which comprise both used and unused dependency code elements. Similarly, dependency scores may be calculated across subtrees of the dependency code using the weights. As an example, a dependency score may be a sum of the weights across each subtree, indicating a complexity of replacing the code. Alternatively, the dependency score may be a ratio of used (or unused) dependency code to total dependency code (e.g., weights associated with used or unused nodes to weights across all nodes of a particular subtree). The dependency score may be compared to a threshold, which may be configurable (e.g., by a user). When a particular dependency score for a particular subtree meets the threshold, the system may generate replacement dependency code 130 comprising dependency code elements in the particular subtree but not the unused code elements in the subtree. Generating replacement code may be performed using a variety of source code techniques. As illustrated in an example below, some embodiments may generate a generative AI prompt and use a generative AI to generate semantically equivalent code, for example. Dependency analyzer 103 may then use the replacement dependency code 130 with the application source code 101, for example. On the other hand, when the dependency score does not meet the threshold, dependency analyzer 103 may use the dependency code associated with nodes of the particular subtree with the application source code 101.

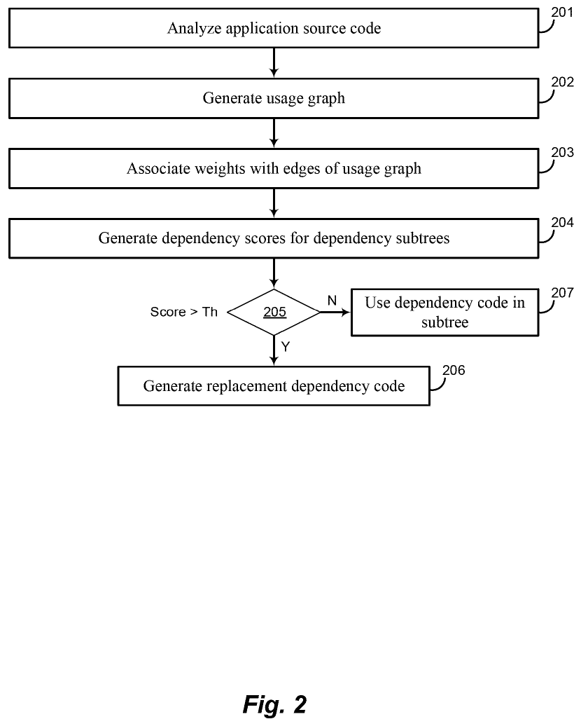

FIG. 2 illustrates a method for code dependency analysis and replacement according to an embodiment. At 201, application source code is analyzed to determine dependencies between code elements of the application source code and dependency code elements of dependency code external to the application source code. The dependency code may include code elements that are unused by the application source code. At 202, a usage graph is generated based on the application source code and dependency code. The usage graph comprises a plurality of nodes corresponding to application source code elements and dependency code elements and a plurality of edges between the nodes corresponding to dependency relations between particular nodes. At 203, weights are associated with a subset of the plurality of edges corresponding to the dependency code elements. At 204, dependency scores are generated based on the weights for a plurality of subtrees of the usage graph comprising the dependency code. At 205, each dependency score is compared to a threshold. At 206, when a particular dependency score for a particular subtree meets the threshold, replacement dependency code is generated comprising dependency code elements in the subtree and not unused code elements in the subtree for use with the application source code. At 207, when the dependency score does not meet the threshold, the dependency code is used with the application source code.

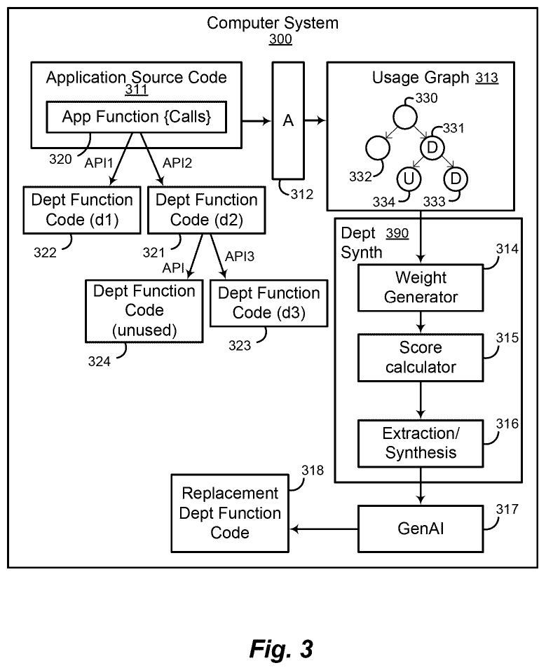

FIG. 3 illustrates an example software system for generating replacement code according another embodiment. In some embodiments, a dependency analyzer may detect little-used 3rd party dependencies that considerably increase the maintenance effort and attack surface while providing little benefit in terms of code reuse. For such little-used dependencies, the dependency analyzer synthetizes semantically equivalent code to replace the original dependency code. Accordingly, the present system and method analyze an application (e.g., application source code 311) and dependency trees of the application's dependency code 321-323, which may be 3^{rd} party open source code, for example. A code analyzer (A) 312 analyzes the application and its dependencies to determine which code of the dependencies is reachable during any application execution. This can be done using e.g. static, dynamic, or other kinds of analyses, for example. The result of the analysis is described by a dependency usage tree, a dependency tree whose edges are annotated with the portion of code used within the interconnected dependencies. Here, code analyzer (A) 312 may analyze the dependency code 321-323 to generate a usage graph 313. In some embodiments, code analyzer 312 may use a wide variety of code analysis tools like static analysis tools (SAST), dynamic analysis tools (DAST), etc.

In this simplified illustrative example, usage graph 313 (aka usage tree) represents the dependency tree, wherein an application function 320 calls dependent function code 321 and 322 using APIs. Dependent function code 321, in turn, calls dependent function code 323 and 324 using APIs, of which code 323 is used and code 324 is unused. Usage tree 313 may be enriched with the information of which API is used for each dependency in the tree, for example. Accordingly, usage graph 313 includes root node 330 corresponding to application function 320, node 331 corresponding to dependent function 321, and node 332 corresponding to dependent function 322, with edges between node 330 and 331 and node 330 and 332 representing direct dependencies. Similarly, usage graph 313 includes node 333 corresponding to dependent function 323 and node 334 corresponding to dependent function 324, with edges between node 331 and 333 and node 331 and 334 representing indirect (aka transitive) dependencies. Each edge of the tree may be annotated with the API used by the parent node. “App--(api1)-->d1” is used to denote the fact that the application invokes the API named “api1” exposed by the direct dependency “d1”. “d2--(api3)-->d3” is used to denote the fact that dependency “d2” invokes the API named “api3” exposed by its direct dependency “d3” (which is a transitive dependency of the application).

Next, a dependency synthesizer 390 analyses the dependency usage tree to determine whether there exist direct dependencies that can be replaced with an amount of code considerably smaller than the amount of code currently imported via the direct and transitive dependencies. This is done by analyzing each subtree. To establish whether a dependency is little-used (and a candidate for replacement), the dependency synthesizer includes a weight generator 314 that associates to each edge among two nodes A and B, a weight W_{AB}. As mentioned above, the weight can be based on different metrics, e.g., lines of code, cyclomatic complexity, number of vulnerabilities, etc. In this example, a score calculator 315 then computes a total weight for each subtree by composing the weights of each of its edges. If the used code of the identified subtree is small, an extraction/synthesis component 316 extracts the portion of used code from the dependencies and feeds it to GenAI 317 to generate semantically equivalent code than can be incorporated into the application.

To establish whether the dependency code elements are little used, embodiments may compare the weight of the subtree against a configurable threshold T, for example. Alternatively, as mentioned above, a ratio of used code over the overall code of the subtree calculated and compared to a threshold. If the ratio is below the threshold, then the code may be replaced. For example, as described further below, if the subtree weight is less than a configurable threshold, extract the used part of code and apply it as an input to a tool able to create semantic clones (e.g., Gen AI 317). The resulting code can be integrated in the application itself (e.g., as a new module), allowing for removal of an entire branch of the original dependency tree that was little used.

As an example, weights may be composed as:

$$W\_Subtree = {\sum }_{i , j ∈ N} {w}_{ij}$$

Where N is the set of nodes of the subtree and wij is the weight associated with the edge from node i to node j.

To extract the used code, extraction/synthesizer 316 uses the information available from the dependency usage tree. Starting from the root of the subtree to be synthesized, it extracts from each dependency the list of functions that are used by its dependent(s).

To generate semantic clones, the used code is fed to a generative artificial intelligence engine, such as a large language model (LLM), such as GPT-4, Mistral, Llama, etc. . . . , together with a suitable prompt, to obtain the code to be incorporated in the application. Synthesized code for the application may be used to replace a path in the dependency tree, thereby removing the corresponding direct dependency and its required (transitive) dependencies, for example.

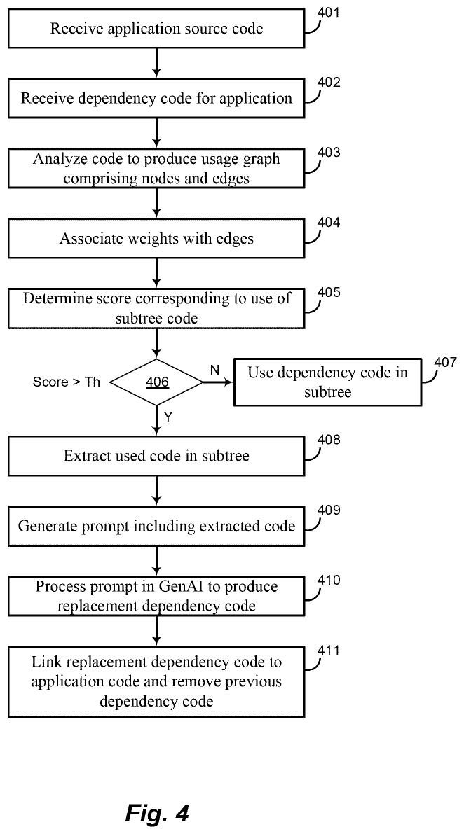

FIG. 4 illustrates an example method of generating replacement code according to another embodiment. At 401, a dependency analyzer receives application source code. At 402, the dependency analyzer receives dependency code for the application. At 403, a code analyzer analyzes the code to produce a usage graph tree data structure in memory comprising nodes and edges. At 404, weights are associated with the edges. At 405, a score is determined corresponding to use of code across subtrees of the dependency code. At 406, the scores are compared to one or more thresholds to determine if any of the code may be replaced. Subtrees with corresponding scores below the threshold may not be replaced as illustrated at 407. At 408, the dependency analyzer extracts dependency code elements of one or more subtrees used by the application source code corresponding to linked nodes of the usage graph. At 409, a generative artificial intelligence (GenAI) prompt is generated. As illustrated in an example below, the prompt may comprise dependency code elements extracted from multiple code elements of the dependency code. At 410, the generative AI prompt is sent to a GenAI engine, where the prompt is processed to produce a replacement dependency code element comprising the combined functionality of the initial used dependency code elements. The replacement dependency code element may comprise no indirect calls, for example. At 411, the dependency analyzer may receive the replacement code element and link the replacement dependency code element to the application code and remove the initial dependency code.

### Illustrative Example

For this example, in the dependency usage tree of FIG. 3, the weights correspond to the lines of code and the threshold 100, i.e., the dependency code should be included in the application if it includes less than 100 lines. The application uses just one function api2 of the direct dependency d2 321 which in turn uses one function api3 of d3 323. It is assumed that d2 invokes api3 in a body made of 10 lines of code. Api3 has 15 lines of code. Therefore, the following values are obtained: wad2=10 (weight of edge between node 330 and 331), wd2d3=15 (weight of edge between node 331 and 332). Accordingly, W_Subtreed2=25 (the sum of the weights for this subtree).

The dependency synthesizer then extracts functions api2 and api3 and feeds them to an LLM. It is assumed that it returns a single function that can be in-lined in the original application.

For illustrative purposes, consider the case where the application imports the d2 dependency to use the api2 “sum_three_numbers( )” of class D2 as follows:

# Body of my app
from d2 import D2
a = 4
b = 2
c = 1
D2.sum_three_numbers(a,b,c)
# ... continues

In turn, the method of class D2 imports the dependency d3 to use the api3 “sum_of_two_numbers( )” of class D3 as follows:

```
# Body of d2
from d3 import D3
def sum_three_numbers(a,b,c):
  # Body of api2
  return a + D3.sum_two_numbers(b,c)
```

Finally, the body of api3 is as follows:

```
# Body of d3
def sum_two_numbers(a,b):
  # Body of api3
  return a + b
```

In this case, the following values are calculated:

$$wad 2 = 1$$

$$wd 2 d 3 = 1$$

$$W\_Subtreed2 = 2$$

Since W_Subtreed2<100, the dependency synthesizer can reduce the dependencies by extracting the functions api2 and api3 and feeding them to openAI to produce a synthetized version of the code to be included directly in the application. An example prompt using GPT4 is as follows: “Given an application invoking a function as follows <body> where <body of D2> and <body of d3> generate a function that replaces used of d2 and d3 in the application.” An example output is as follows:

# Body of my updated app
def sum_three_numbers(a,b,c):
return a + b + c
# Now invoking new function
a = 4
b = 2
c = 1
sum_three_numbers(a,b,c)

The result of the above code directly adds three input numbers without needing to call external modules or functions, which directly replaces the functionality of d2 and d3. It is to be understood that the above example is merely illustrative and a wide range of dependency code and indirect dependency code (one or more layers down) may be similarly replaced in various other embodiments.

It is to be understood that a variety of tools may be used for static code analysis or agents that instrument the code execution to perform dynamic analyses. Because both static and dynamic analysis can result in false negatives (e.g., code erroneously marked as unused), when applying the techniques described herein, some applications may benefit from a combination of both techniques (e.g., combining multiple implementations of each technique simultaneously) to obtain a representation of what is used that is as accurate as possible to minimizing the risk of false negatives, for example.

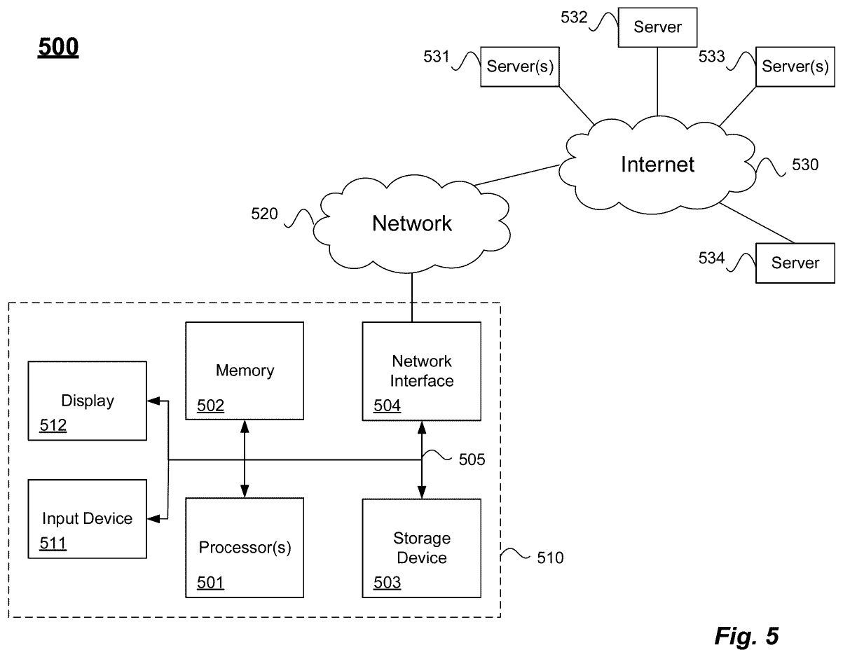

FIG. 5 illustrates hardware of a special purpose computing system 500 configured according to the above disclosure. The following hardware description is merely one example. It is to be understood that a variety of computers topologies may be used to implement the above-described techniques. An example computer system 510 is illustrated in FIG. 5. Computer system 510 includes a bus 505 or other communication mechanism for communicating information, and one or more processor(s) 501 coupled with bus 505 for processing information. Computer system 510 also includes memory 502 coupled to bus 505 for storing information and instructions to be executed by processor 501, including information and instructions for performing some of the techniques described above, for example. Memory 502 may also be used for storing programs executed by processor(s) 501. Possible implementations of memory 502 may be, but are not limited to, random access memory (RAM), read only memory (ROM), or both. A storage device 503 is also provided for storing information and instructions. Common forms of storage devices include, for example, a hard drive, a magnetic disk, an optical disk, a CD-ROM, a DVD, solid state disk, a flash or other non-volatile memory, a USB memory card, or any other electronic storage medium from which a computer can read. Storage device 503 may include source code, binary code, or software files for performing the techniques above, for example. Storage device 503 and memory 502 are both examples of non-transitory computer readable storage mediums (aka, storage media).

In some systems, computer system 510 may be coupled via bus 505 to a display 512 for displaying information to a computer user. An input device 511 such as a keyboard, touchscreen, and/or mouse is coupled to bus 505 for communicating information and command selections from the user to processor 501. The combination of these components allows the user to communicate with the system. In some systems, bus 505 represents multiple specialized buses for coupling various components of the computer together, for example.

Computer system 510 also includes a network interface 504 coupled with bus 505. Network interface 504 may provide two-way data communication between computer system 510 and a local network 520. Network 520 may represent one or multiple networking technologies, such as Ethernet, local wireless networks (e.g., WiFi), or cellular networks, for example. The network interface 504 may be a wireless or wired connection, for example. Computer system 510 can send and receive information through the network interface 504 across a wired or wireless local area network, an Intranet, or a cellular network to the Internet 530, for example. In some embodiments, a frontend (e.g., a browser), for example, may access data and features on backend software systems that may reside on multiple different hardware servers on-prem 531 or across the network 530 (e.g., an Extranet or the Internet) on servers 532-534. One or more of servers 532-534 may also reside in a cloud computing environment, for example.

### FURTHER EXAMPLES

Each of the following non-limiting features in the following examples may stand on its own or may be combined in various permutations or combinations with one or more of the other features in the examples below. In various embodiments, the present disclosure may be implemented as a system, method, or computer readable medium.

Embodiments of the present disclosure may include systems, methods, or computer readable media. In one embodiment, the present disclosure includes computer system comprising: at least one processor and at least one non-transitory computer readable medium (e.g., memory) storing computer executable instructions that, when executed by the at least one processor, cause the computer system to perform methods as described herein and in the following examples. In another embodiment, the present disclosure includes a non-transitory computer-readable medium storing computer-executable instructions that, when executed by at least one processor, perform the methods as described herein and in the following examples.

In one embodiment, the present disclosure includes a computer implemented method comprising: analyzing application source code to determine dependencies between code elements of the application source code and dependency code elements of dependency code external to the application source code, wherein the dependency code comprises a plurality of unused code elements; generating a usage graph based on the application source code and dependency code, the usage graph comprising a plurality of nodes corresponding to application source code elements and dependency code elements and a plurality of edges between the nodes corresponding to dependency relations between particular nodes; associating a plurality of weights with a subset of the plurality of edges corresponding to the dependency code elements; generating, based on the plurality of weights, a plurality of dependency scores for a plurality of subtrees of the usage graph comprising the dependency code; comparing each dependency score to a threshold; and when a particular dependency score for a particular subtree meets the threshold, generating replacement dependency code comprising dependency code elements in the subtree and not unused code elements in the subtree for use with the application source code, and when the dependency score does not meet the threshold, using the dependency code with the application source code.

In one embodiment, the dependency code elements are functions.

In one embodiment, the application source code calls the dependency code elements using an application program interface (API).

In one embodiment, analyzing application source code comprises a static analysis of the application source code and a dynamic analysis of the application source code performed during execution.

In one embodiment, the plurality of weights correspond to a number of lines of code associated with particular dependency code elements.

In one embodiment, the plurality of weights correspond to a cyclomatic complexity associated with particular dependency code elements.

In one embodiment, the plurality of weights correspond to a number of detected known vulnerabilities associated with particular dependency code elements.

In one embodiment, the threshold is configurable.

In one embodiment, generating replacement dependency code comprises: extracting first dependency code elements of the subtree used by the application source code corresponding to a plurality of linked nodes of the usage graph; generating a generative artificial intelligence (AI) prompt comprising the first dependency code elements; sending the generative AI prompt to a generative artificial intelligence engine; and receiving a replacement code element comprising the combined functionality of the first dependency code elements, wherein the replacement dependency code is the replacement code element.

The above description illustrates various embodiments along with examples of how aspects of some embodiments may be implemented. The above examples and embodiments should not be deemed to be the only embodiments, and are presented to illustrate the flexibility and advantages of some embodiments as defined by the following claims. Based on the above disclosure and the following claims, other arrangements, embodiments, implementations, and equivalents may be employed without departing from the scope hereof as defined by the claims.

What is claimed is:

1. A computer implemented method comprising:
analyzing application source code to determine dependencies between code elements of the application source code and dependency code elements of dependency code external to the application source code, wherein the dependency code comprises a plurality of unused code elements;
generating a usage graph based on the application source code and dependency code, the usage graph comprising a plurality of nodes corresponding to application source code elements and dependency code elements and a plurality of edges between the nodes corresponding to dependency relations between particular nodes;
associating a plurality of weights with a subset of the plurality of edges corresponding to the dependency code elements;
generating, based on the plurality of weights, a plurality of dependency scores for a plurality of subtrees of the usage graph comprising the dependency code;
comparing each dependency score to a threshold; and
when a particular dependency score for a particular subtree meets the threshold, generating replacement dependency code comprising dependency code elements in the subtree and not unused code elements in the subtree for use with the application source code, and when the dependency score does not meet the threshold, using the dependency code with the application source code.

2. The method of claim 1, wherein the dependency code elements are functions.

3. The method of claim 1, wherein the application source code calls the dependency code elements using an application program interface (API).

4. The method of claim 1, wherein analyzing application source code comprises a static analysis of the application source code and a dynamic analysis of the application source code performed during execution.

5. The method of claim 1, wherein the plurality of weights correspond to a number of lines of code associated with particular dependency code elements.

6. The method of claim 1, wherein the plurality of weights correspond to a cyclomatic complexity associated with particular dependency code elements.

7. The method of claim 1, wherein the plurality of weights correspond to a number of detected known vulnerabilities associated with particular dependency code elements.

8. The method of claim 1, wherein the threshold is configurable.

9. The method of claim 1, wherein generating replacement dependency code comprises:
extracting first dependency code elements of the subtree used by the application source code corresponding to a plurality of linked nodes of the usage graph;
generating a generative artificial intelligence (AI) prompt comprising the first dependency code elements;
sending the generative AI prompt to a generative artificial intelligence engine; and
receiving a replacement code element comprising the combined functionality of the first dependency code elements,
wherein the replacement dependency code is the replacement code element.

10. A computer system comprising:
at least one processor;
at least one non-transitory computer-readable medium storing computer-executable instructions that, when executed by the at least one processor, cause the computer system to execute a computer implemented method comprising:
analyzing application source code to determine dependencies between code elements of the application source code and dependency code elements of dependency code external to the application source code, wherein the dependency code comprises a plurality of unused code elements;
generating a usage graph based on the application source code and dependency code, the usage graph comprising a plurality of nodes corresponding to application source code elements and dependency code elements and a plurality of edges between the nodes corresponding to dependency relations between particular nodes;
associating a plurality of weights with a subset of the plurality of edges corresponding to the dependency code elements;
generating, based on the plurality of weights, a plurality of dependency scores for a plurality of subtrees of the usage graph comprising the dependency code;
comparing each dependency score to a threshold; and
when a particular dependency score for a particular subtree meets the threshold, generating replacement dependency code comprising dependency code elements in the subtree and not unused code elements in the subtree for use with the application source code, and when the dependency score does not meet the threshold, using the dependency code with the application source code.

11. The computer system of claim 10, wherein the dependency code elements are functions.

12. The computer system of claim 10, wherein the application source code calls the dependency code elements using an application program interface (API).

13. The computer system of claim 10, wherein analyzing application source code comprises a static analysis of the application source code and a dynamic analysis of the application source code performed during execution.

14. The computer system of claim 10, wherein generating replacement dependency code comprises:
extracting first dependency code elements of the subtree used by the application source code corresponding to a plurality of linked nodes of the usage graph;
generating a generative artificial intelligence (AI) prompt comprising the first dependency code elements;
sending the generative AI prompt to a generative artificial intelligence engine; and
receiving a replacement code element comprising the combined functionality of the first dependency code elements,
wherein the replacement dependency code is the replacement code element.

15. A non-transitory computer-readable medium storing computer-executable instructions that, when executed by at least one processor of a computer system, cause the computer system to execute a computer implemented method comprising:
analyzing application source code to determine dependencies between code elements of the application source code and dependency code elements of dependency code external to the application source code, wherein the dependency code comprises a plurality of unused code elements;
generating a usage graph based on the application source code and dependency code, the usage graph comprising a plurality of nodes corresponding to application source code elements and dependency code elements and a plurality of edges between the nodes corresponding to dependency relations between particular nodes;
associating a plurality of weights with a subset of the plurality of edges corresponding to the dependency code elements;
generating, based on the plurality of weights, a plurality of dependency scores for a plurality of subtrees of the usage graph comprising the dependency code;
comparing each dependency score to a threshold; and
when a particular dependency score for a particular subtree meets the threshold, generating replacement dependency code comprising dependency code elements in the subtree and not unused code elements in the subtree for use with the application source code, and when the dependency score does not meet the threshold, using the dependency code with the application source code.

16. The non-transitory computer-readable medium of claim 15, wherein analyzing application source code comprises a static analysis of the application source code and a dynamic analysis of the application source code performed during execution.

17. The non-transitory computer-readable medium of claim 15, wherein the plurality of weights correspond to a number of lines of code associated with particular dependency code elements.

18. The non-transitory computer-readable medium of claim 15, wherein the plurality of weights correspond to a cyclomatic complexity associated with particular dependency code elements.

19. The non-transitory computer-readable medium of claim 15, wherein the plurality of weights correspond to a number of detected known vulnerabilities associated with particular dependency code elements.

20. The non-transitory computer-readable medium of claim 15, wherein generating replacement dependency code comprises:
extracting first dependency code elements of the subtree used by the application source code corresponding to a plurality of linked nodes of the usage graph;
generating a generative artificial intelligence (AI) prompt comprising the first dependency code elements;
sending the generative AI prompt to a generative artificial intelligence engine; and
receiving a replacement code element comprising the combined functionality of the first dependency code elements,
wherein the replacement dependency code is the replacement code element.
